(19) United States
(12) Patent Application Publication
(10) Pub. No.: US 2026/0189270 A1
(43) Pub. Date: Jul. 2, 2026

(54) CHANNEL RECONSTRUCTION

(71) Applicant: Nokia Solutions (Shanghai) Co., Ltd., Shanghai (CN)

(72) Inventors: Zhihang LI, Shanghai (CN); Tao YANG, Shanghai (CN); Hao LIU, Shanghai (CN); Yan ZHAO, Shanghai (CN); Nuan SONG, Shanghai (CN)

(73) Assignee: Nokia Solutions (Shanghai) Co., Ltd., Shanghai (CN)

(21) Appl. No.: 19/128,839

(22) PCT Filed: Nov. 15, 2022
(86) PCT No.: PCT/CN2022/131920

§ 371 Date: May 9, 2025

(51) Int. Cl. H04B 7/0413; H04L 25/02

(52) U.S. Cl. CPC H04B 7/0413; H04L 25/0226

(57) ABSTRACT

Embodiments of the present disclosure relate to devices, methods, apparatuses and computer readable storage media of channel reconstruction. In a method, a first device receives a signal from a second device via a set of receiving antenna elements over a channel, the signal is associated with a plurality of pilots transmitted by the second device. The first device determines an estimate of a plurality of pairs of and receiving angles associated with the channel, based on the received signal, the plurality of pilots and a plurality of orthogonal spatial directions. A spatial direction of the plurality of orthogonal spatial directions is indicated by a pair of transmitting and receiving spatial frequencies. Then, the first device reconstructs the channel based on the received signal, the plurality of pilots, and the estimate of the plurality of pairs of and receiving angles.

### FIELDS

Various example embodiments of the present disclosure generally relate to the field of telecommunication and in particular, to devices, methods, apparatuses and computer readable storage medium for channel reconstruction.

### BACKGROUND

As a millimetre wave (mmWave) frequency band has higher carrier frequencies and a larger bandwidth than a below-6 GHz frequency band, it is a potential candidate technology for a future wireless communication system which needs to provide high data throughput and various applications. In order to compensate a severe propagation loss and bring huge spectral efficiency boosting, a multi-input multi-output (MIMO) technology may be implemented for a mmWave system. In a mmWave MIMO communication system, a channel may comprise several clusters, and thus physical-layer parameters may comprise parameters associated with the respective clusters. Each of these clusters may have its own properties, such as a complex path gain, an array response vector corresponding to an angle of departure (AoD) and an angle of arrival (AoA), and/or the like. To improve spectrum efficiency (SE) of the system, an accurate channel estimation and high-efficient beamforming may be needed.

### SUMMARY

In a first aspect of the present disclosure, there is provided a first device. The first device comprises at least one processor; and at least one memory storing instructions that, when executed by the at least one processor, cause the first device at least to perform: receiving a signal from a second device via a set of receiving antenna elements over a channel, the signal associated with a plurality of pilots transmitted by the second device; determining an estimate of a plurality of pairs of and receiving angles associated with the channel, based on the received signal, the plurality of pilots and a plurality of orthogonal spatial directions, a spatial direction of the plurality of orthogonal spatial directions being indicated by a pair of transmitting receiving spatial frequencies; and reconstructing the channel based on the received signal, the plurality of pilots, and the estimate of the plurality of pairs of transmitting and receiving angles.

In a second aspect of the present disclosure, there is provided a second device. The second device comprises at least one processor; and at least one memory storing instructions that, when executed by the at least one processor, cause the second device at least to perform: transmitting, to a first device, via a set of transmitting antennas elements, a plurality of pilots with a pilot pattern, wherein in the pilot pattern, a group of pilots of the plurality of pilots are active and other pilots of the plurality of pilots are muted; and receiving channel state information from the first device.

In a third aspect of the present disclosure, there is provided a method. The method comprises: at a first device, receiving a signal from a second device via a set of receiving antenna elements over a channel, the signal associated with a plurality of pilots transmitted by the second device; determining an estimate of a plurality of pairs of and receiving angles associated with the channel, based on the received signal, the plurality of pilots and a plurality of orthogonal spatial directions, a spatial direction of the plurality of orthogonal spatial directions being indicated by a pair of transmitting and receiving spatial frequencies; and reconstructing the channel based on the received signal, the plurality of pilots, and the estimate of the plurality of pairs of and receiving angles.

In a fourth aspect of the present disclosure, there is provided a method. The method comprises: at a second device, transmitting, to a first device, via a set of transmitting antennas elements, a plurality of pilots with a pilot pattern, wherein in the pilot pattern, a group of pilots of the plurality of pilots are active and other pilots of the plurality of pilots are muted; and receiving channel state information from the first device.

In a fifth aspect of the present disclosure, there is provided a first apparatus. The first apparatus comprises means for receiving a signal from a second device via a set of receiving antenna elements over a channel, the signal associated with a plurality of pilots transmitted by the second device; means for determining an estimate of a plurality of pairs of and receiving angles associated with the channel, based on the received signal, the plurality of pilots and a plurality of orthogonal spatial directions, a spatial direction of the plurality of orthogonal spatial directions being indicated by a pair of transmitting and receiving spatial frequencies; and means for reconstructing the channel based on the received signal, the plurality of pilots, and the estimate of the plurality of pairs of and receiving angles.

In a sixth aspect of the present disclosure, there is provided a second apparatus.

The second apparatus comprises means for transmitting, to a first device, via a set of transmitting antennas elements, a plurality of pilots with a pilot pattern, wherein in the pilot pattern, a group of pilots of the plurality of pilots are active and other pilots of the plurality of pilots are muted; and means for receiving channel state information from the first device.

In a seventh aspect of the present disclosure, there is provided a computer readable medium. The computer readable medium comprises instructions stored thereon for causing an apparatus to perform at least the method according to the third or fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example structure of a communication system according to some example embodiments of the present disclosure;

FIG. 3 illustrates a flowchart of an example method of channel reconstruction in accordance with some example embodiments of the present disclosure;

FIG. 4 illustrates a flowchart of an example channel reconstruction process implemented by a first device according to some example embodiments of the present disclosure;

FIG. 5 illustrates a flowchart of a method implemented at a second device according to some example embodiments of the present disclosure;

FIG. 6 illustrates a flowchart of an example process of pilot muting implemented by the second device according to some example embodiments of the present disclosure;

FIG. 7 illustrates a signaling diagram of channel reconstruction according to some example embodiments of the present disclosure;

FIG. 8 illustrates an example graph of spectral efficiency (SE) versus signal-noise ratio (SNR) of different algorisms according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “spatial frequency”, also called wave number, refers to a characteristic of any structure that is periodic across positions in space. The spatial frequency is a measure of how often the structure repeats per unit of distance. The spatial frequency can be analyzed by Fourier transform.

To improve spectrum efficiency (SE) of a mmWave MIMO communication system, an accurate channel estimation and high-efficient beamforming may be needed. Compared to the channel estimation at an antenna port level, the channel estimation at an antenna element level may further improve spectral efficiency (SE). However, if a subspace fitting based channel estimation approach is used at the antenna element level, searching complexity may be too high, and additional cumulative errors may be induced due to the estimation of the AoA and/or AoD of every path. If a compressive sensing based channel estimation approach is used, pilots may be transmitted by all antenna elements which may cause incomplete spatial space coverage. Therefore, the spectral efficiency may be deteriorated. There is a need to obtain accurate channel estimation with low complexity.

There may be several issues for channel reconstruction. For example, in the process of channel reconstruction, the number of pilots is constrained to a coherence time of a channel. Thus, a pattern of pilots at a transmitting (Tx) side may be designed to provide an accurate reconstruction of the channel while transmitting overhead may be decreased. As another example, searching grids at a receiving (Rx) side may be designed to decrease the searching complexity. Based on the obtained information associated with the channel, the channel may be reconstructed at a Rx side.

In the third-generation partnership project (3GPP) Release 16 (Rel-16), a multi-hierarchical beam selection scheme may be utilized to estimate the AoA and/or AoD of the channel. For example, a gNB may first perform a cell-specific beam sweeping procedure, named P1, with wide analog beams. A UE may measure reference signal receiving power (RSRP) of the wide beams and feedback a beam identification (ID) corresponding to a beam with the maximal RSRP. A coarse Tx beam may be chosen at this procedure. Then, the gNB may perform a UE-specific beam sweeping procedure, named P2, with narrow analog beams. Since the gNB knows the beam ID of the best wide beam at P1, P2 may be performed locally around the best wide beam. The UE may measure the RSRP of the narrow beams and feedback the beam ID corresponding to the beam with the maximal RSRP similarly. An accurate Tx beam is chosen at P2. The next procedure, named P3, is similar with P2, in which the Rx beam of UE is chosen.

Multiple signal classification (MUSIC) is a subspace fitting algorithm. Assuming that a signal subspace is orthogonal to a noise subspace, the noise subspace may be obtained at the Rx side by performing the eigen value decomposition of a covariance matrix of the received signal. Then, the AoA and the AoD of the channel may be estimated by searching a set of directional grids. After that, complex channel gains may be obtained by using least square algorithm. Since MUSIC is an on-grid algorithm, the estimated AoA and/or AoD may be set to predefined directional grids. However, the real AoA and AoDs are continuous variables, which implies that MUSIC may inherently bring angle estimation errors between the real angles and the estimated angles. Besides, MUSIC is designed to estimate the AoAs and AoDs of all paths. Cumulative errors due to the estimation errors of all the paths may significantly deteriorate the performance.

Orthogonal matching pursuit (OMP) is a compressive sensing algorithm. Due to the sparse property of the mmWave channel, OMP may be used to reconstruct the channel by successively correlating a residual signal with a compressive sensing measurement matrix and recursively estimating the desired subspace. The OMP based algorithm may need beamformed measurement samples to reconstruct the channel. Pilots sent from all antenna elements may suffer from deep fading since narrow beams are formulated. There is a need of designing the measurement matrix to ensure a low searching complexity and efficient channel reconstruction.

Example embodiments of the present disclosure propose a novel channel reconstruction scheme. The scheme reconstructs a channel by searching over a spatial frequency subspace represented by a plurality of orthogonal spatial directions. A spatial direction of the plurality of orthogonal spatial directions is indicated by a pair of transmitting and receiving spatial frequencies.

In this way, the channel reconstructed may be more accurate. Based on the simulation results as will discussed in the following paragraphs, compared with the OMP algorithm, the scheme according to example embodiments of present disclosure may improve the spectral efficiency (SE).

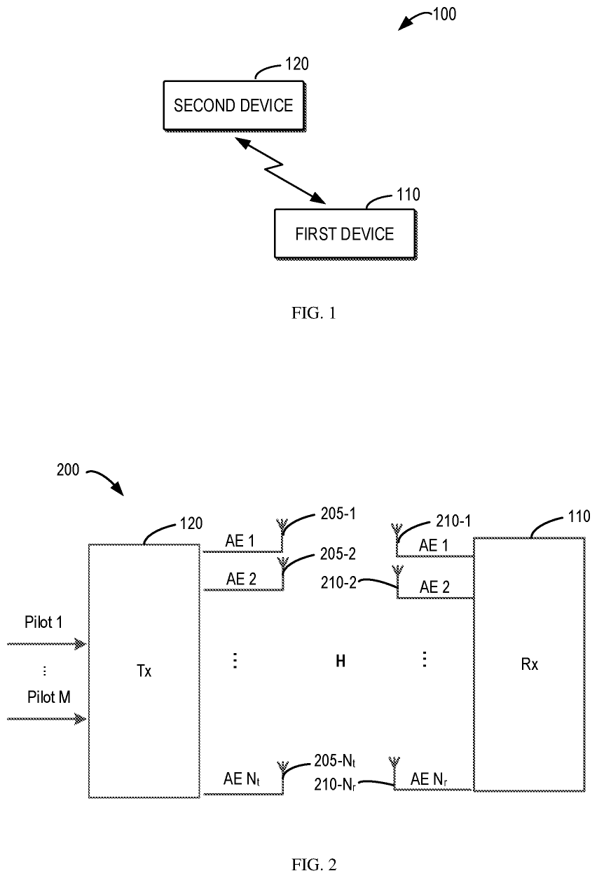

FIG. 1 illustrates an example communication environment 100 in which example embodiments of the present disclosure can be implemented. In the communication environment 100, a plurality of communication devices, including a first device 110 and a second device 120, can communicate with each other.

In the following, for the purpose of illustration, some example embodiments are described with the first device 110 operating as a transmitting (Tx) device (or a transmitter) and the second device 120 operating as a receiving (Rx) device (or a receiver). It is possible that the second device 120 operates as a receiver, and the first device 110 operates as a transmitter.

In some example embodiments, the first device 110 may operate as a terminal device, and the second device 120 may operate as a network device. It is to be understood that operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is the Tx device and the first device 110 is a Rx device. In UL, the first device 110 is a Tx device and the second device 120 is a Rx device. In some example embodiments, the first and second devices 110 and 120 may both terminal devices and communicate in sidelink (SL). In SL communications, one of the first and second devices 110 and 120 is a Tx device, and the other of the first and second devices 110 and 120 is a Rx device.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some example embodiments, the first and second devices 110 and 120 may be provided with a plurality of antenna elements. During the communication from the second device 120 (as a Tx device) to the first device 110 (as a Rx device), there may be a plurality of paths between a plurality of Tx antenna elements (AEs) of the second device 120 and a plurality of Rx AEs of the first device 110. For channel reconstruction, pilots may be transmitted from the second device 120 to the first device 110 via the plurality of AEs at both the two devices 110 and 120. An example process of channel reconstruction will be discussed below with reference to FIG. 2.

FIG. 2 shows an example structure of a communication system 200 according to some example embodiments of the present disclosure.

As shown in FIG. 2, the communication system 200, which may be a mmWave MIMO communication system, comprises the second device 120 as a Tx device and the first device 110 as a Rx device. The second device 120 is provided with Nₜ Tx AEs 205-1, 205-2, . . . , 205-Nₜ, labeled as AE1, AE2, . . . , AE Nₜ. The first device 110 is provided with Nᵣ Rx AEs 210-1, 210-2, . . . , 205-Nᵣ, labeled as AE1, AE2, . . . , AE Nᵣ. The Tx AEs and Rx AEs in combination may be referred to as a transmitting and receiving antenna array.

Considering a coherence interval of a channel between the first and second devices 110 and 120, it is assumed the number of pilots is M, labeled as Pilot 1, . . . , Pilot M. One pilot is transmitted at a transmitting time interval. The pilot set may be denoted as X=[x₁, . . . , x_{M}]^{T} where E[|xₖ|²]=1 for k=1, . . . M, then a received signal associated with the pilot xₖ may be represented as

$${y}_{k} = H {x}_{k} + {n}_{k} \qquad ( 1 )$$

where H represents a Nᵣ×Nₜ physical channel; and nₖ∈ [symbol] ^{N}^{ᵣ} represents a noise vector, which may follows the distribution CN(0,σ²). σ²=1/γ and γ is the target SNR. The received signals associated with the M pilots may be combined as a matrix and denoted as

$$Y = [ {y}_{1} , {y}_{2} , … {y}_{M} ] = H X + N \qquad ( 2 )$$

where N=[n₁, n₂, . . . n_{M}] represents a noise matrix of all pilots.

In some example embodiments, uniform linear array (ULA) may be implemented at both the second device 120 (such as a gNB) and the first device 110 (such as a UE). If a ray-cluster based spatial channel model is employed, then H may be represented as

$$H = \sqrt{{N}_{r} \cdot {N}_{t}} {\sum }_{l = 1}^{L} {a}_{l} {a}_{r} ( {ϕ}_{l} ) {a}_{t}^{H} ( {θ}_{l} ) \qquad ( 3 )$$

where aₗ, φₗ, θₗ represent a complex path gain, a AoA and a AoD of a path l, respectively. The total path number is L. aᵣ(⋅), aₜ(⋅) are array response vectors of the Rx AEs and the Tx AEs in the receiving and transmitting antenna array.

λ represents a wavelength of a carrier frequency. dₜ, dᵣ represent absolute inter-element distances of the Rx AEs and the Tx AEs in the transmitting and receiving antenna array, respectively. Then, Dₜ=dₜ/λ, Dᵣ=dᵣ/λ represent relative inter-element distances of the Rx AEs and the Tx AEs in the transmitting and receiving antenna array, respectively. The array response vectors may be shown as:

$${a}_{t} ( {θ}_{l} ) = {\frac{1}{\sqrt{{N}_{t}}} [ 1 , {e}^{j 2 π {D}_{t} sin ( {θ}_{l} )} , … , {e}^{j 2 π {D}_{t} ( {N}_{t} - 1 ) sin ( {θ}_{l} )} ]}^{T} \qquad ( 4 )$$

$${a}_{r} ( {ϕ}_{l} ) = {\frac{1}{\sqrt{{N}_{r}}} [ 1 , {e}^{j 2 π {D}_{r} sin ( {ϕ}_{l} )} , … , {e}^{j 2 π {D}_{r} ( {N}_{r} - 1 ) sin ( {ϕ}_{l} )} ]}^{T} \qquad ( 5 )$$

∂=2πDₜ sin (θ) and φ=2πDᵣ sin(φ) may be defined as the transmitting and receiving spatial frequencies. Then, the equation (4) and (5) may be represented as

$${a}_{t} ( ϑ ) = {\frac{1}{\sqrt{{N}_{t}}} [ 1 , {e}^{j ϑ} , … , {e}^{j ( {N}_{t} - 1 ) ϑ} ]}^{T} \qquad ( 6 )$$

$${a}_{r} ( φ ) = {\frac{1}{\sqrt{{N}_{r}}} [ 1 , {e}^{j φ} , … , {e}^{j ( {N}_{r} - 1 ) φ} ]}^{T} \qquad ( 7 )$$

It is noted that in the above equations and the following equations, (⋅)^{T} and (⋅)^{H} may denote transpose and conjugate transpose; conj(⋅) may denote the conjugate operation; vec(⋅) may denote the vectorization operation; ∥⋅∥_{F} denote the Frobenius norm; CN(μ,σ²) may denote complex a Gaussian vector with a mean u and a covariance 62; tr(x) means the trace of x; Diag(x) means reshaping the vector x as a diagonal matrix; and [symbol] denotes the complex set.

To reconstruct the channel, H needs to be determined. In some example embodiments, a plurality of pairs of transmitting and receiving angles (such as AoAs and AoDs, represented by φₗ,θₗ, for example) associated with the channel may be estimated by searching over two-dimensional (2D) spatial frequency grids, each grid representing a pair of transmitting and receiving spatial frequencies. In this way, the searching complexity may be reduced, and the channel may be reconstructed more effectively or efficiently.

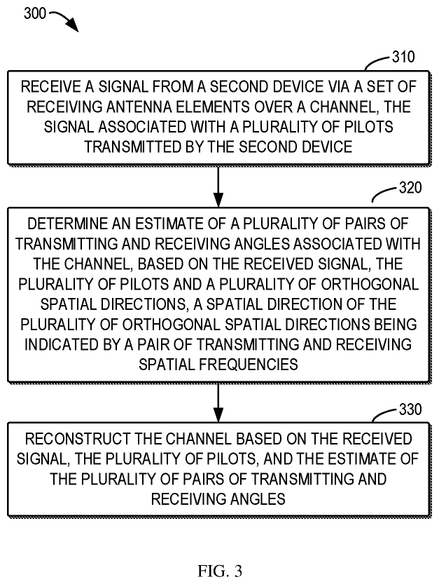

FIG. 3 shows a flowchart of an example method 300 of channel reconstruction in accordance with some example embodiments of the present disclosure. For the purpose of discussion, the method 300 will be described from the perspective of the first device 110 in FIGS. 1 and 2.

At block 310, the first device 110 receives a signal from the second device 120 via a set of receiving antenna elements (such as Rx AEs 210-1, 210-2, . . . , 205-Nᵣ) over a channel. The received signal, such as Y in the equation (2), are associated with a plurality of pilots (such as Pilot 1, . . . , Pilot M) transmitted by the second device 120.

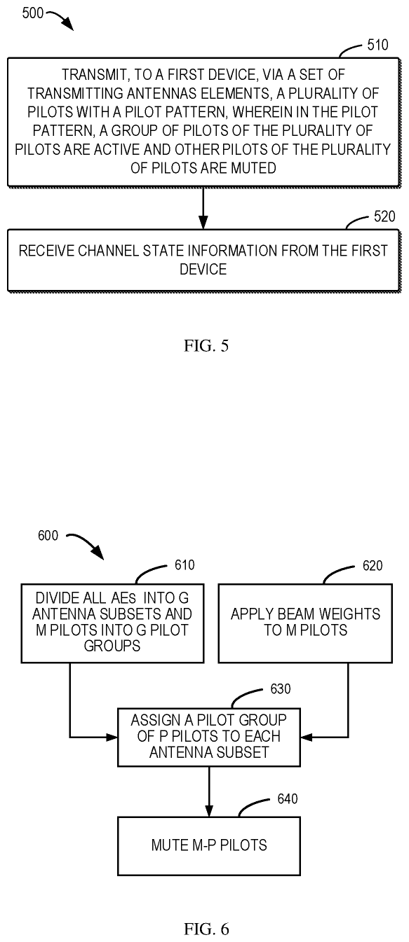

In some example embodiments, the plurality of pilots has a pilot pattern. In the pilot pattern, a group of pilots of the plurality of pilots may be active, and other pilots of the plurality of pilots may be muted. In some example embodiments, in the pilot pattern, transmitting angles of the plurality of pilots may be uniformly distributed in a spatial frequency range. In some example embodiments, the first device 110 may receive an indication of the pilot pattern from the second device 120. Some example embodiments with respect to the design of the pilots will be discussed in the following paragraphs with reference to FIGS. 5 and 6.

At block 320, the first device 110 determines an estimate of a plurality of pairs of transmitting and receiving angles (such as AoAs and AoDs) associated with the channel. The determination is based on the received signal, the plurality of pilots and a plurality of orthogonal spatial directions. A spatial direction of the plurality of orthogonal spatial directions is indicated by a pair of transmitting and receiving spatial frequencies.

In some example embodiments, a complete 2D orthogonal directional matrix may be designed by combining Tx and Rx spatial frequency grids to transform an antenna space into a sparse spatial frequency space, to ensure accurate channel reconstruction with low searching complexity.

For example, the Tx grids may be denoted as

$${b}_{t} ( {ϑ}_{{n}_{t}} ) = {a}_{t} ( {ϑ}_{{n}_{t}} ) \qquad ( 8 )$$

where ∂ₙ_{ₜ}={2πDₜ[2(nₜ−1)/Nₜ−1]|nₜ=1, 2, . . . Nₜ} represents the transmitting spatial frequency.

Similarly, the Rx grids may be denoted as

$${b}_{r} ( {φ}_{{n}_{r}} ) = {a}_{r} ( {φ}_{{n}_{r}} ) \qquad ( 9 )$$

where φₙ_{ᵣ}={2πDᵣ[2(nᵣ−1)/Nᵣ−1]|nᵣ=1, 2, . . . Nᵣ} represent the receiving spatial frequency.

Accordingly, the complete 2D orthogonal directional matrix may be shown as

$${B}_{g} = \{ b ( {ϑ}_{{n}_{t}} , {φ}_{{n}_{r}} ) \} = \{ conj [ {b}_{t} ( {ϑ}_{{n}_{t}} ) ] ⊗ {b}_{r} ( {φ}_{{n}_{r}} ) \vert {n}_{t} = 1 , 2 , … , {N}_{t} , {n}_{r} = 1 , 2 , … {N}_{r} \} \qquad ( 10 )$$

Thus, the 2D orthogonal directional matrix may cover the entire spatial space meanwhile the searching complexity may be decreased. Such a design of the 2D orthogonal directional matrix may be referred to as a 2D orthogonal directional matrix design.

In some example embodiments, to determine the estimate of the plurality of pairs of transmitting and receiving angles, the first device 110 may iteratively search over the plurality of orthogonal spatial directions based on the received signal and the plurality of pilots.

For example, in the case that a 2D orthogonal directional matrix generated by combining Tx and Rx spatial frequency grids is used to represent the searching spatial space, the plurality of pairs of transmitting and receiving angles may be represented by a 2D directional matrix specific to the first device 110, also referred to as a specific 2D directional matrix. The specific 2D directional matrix may comprise several 2D directional vectors specific to the first device 110 and may be estimated based on the 2D orthogonal directional matrix. To estimate the specific 2D directional matrix, searching may be performed successively over the 2D spatial frequency grids of the 2D orthogonal directional matrix. During the successive searching process, the specific 2D directional matrix may be cumulatively determined, which may represent a target spatial frequency subspace.

In some example embodiments, the searching may be performed by iteratively updating a residual signal of the received signal. For example, in the one-round searching over the plurality of orthogonal spatial directions, the first device 110 may search, based on the received signal, for a first spatial direction from the plurality of orthogonal spatial directions. Based on the first spatial direction, the first device 110 may determine a candidate estimate of the plurality of pairs of transmitting and receiving angles. Then, the first device 110 may update a residual signal of the received signal based on the candidate estimate and the plurality of pilots. As an example, the residual signal may be updated by projecting onto the orthogonal subspace formed by the plurality of orthogonal spatial directions. Based on the residual signal of the received signal, the first device 110 may search for a second spatial direction from remaining spatial directions of the plurality of orthogonal spatial directions, and then the first device 110 may update the candidate estimate based on the second spatial direction.

In some example embodiments, the iterative searching may be ceased based on a comparison of norm of the residual signal and a predetermined threshold. For example, after updating the residual signal in one-round searching, the norm of the residual signal may be compared with the predetermined threshold. If the norm of the residual signal is equal to or larger than the predetermined threshold, the searching may be continued. If the norm of the residual signal is smaller, the searching may be ceased.

At block 330, based on the received signal, the plurality of pilots, and the estimate of the plurality of pairs of transmitting and receiving angles, the first device 110 reconstructs the channel. To reconstruct the channel, in some example embodiments, the first device 110 may determine a channel gain associated with the channel, based on the received signal, the plurality of pilots, and the estimate of the plurality of pairs of transmitting and receiving angles. Then, the first device 110 may reconstruct the channel based on the channel gain and the estimate of the plurality of pairs of transmitting and receiving angles.

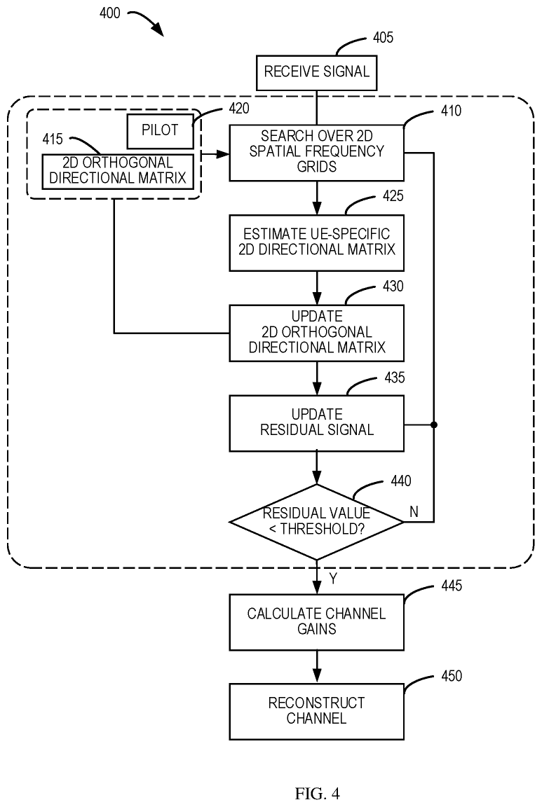

An example channel reconstruction process will be discussed below with reference to FIG. 4.

FIG. 4 shows a flowchart of an example channel reconstruction process 400 implemented by the first device 110 according to some example embodiments of the present disclosure. For the purpose of discussion, the process 400 will be described with reference to FIGS. 1 and 2.

In this example, the first device 110 may operate as a UE. The plurality of orthogonal spatial directions may be represented by a 2D orthogonal directional matrix comprising 2D spatial frequency grids. Accordingly, the plurality of pairs of transmitting and receiving angles to be estimated may be represented by a specific 2D directional matrix, also referred to as a UE-specific 2D directional matrix.

As shown in FIG. 4, in the process 400, at block 405, the first device 110 may receive a signal. At block 410, the first device 110 may search over 2D spatial frequency grids of a 2D orthogonal directional matrix 415 based on pilots 420, such as Pilot 1, . . . , Pilot M as shown in FIG. 2. At block 425, the first device 110 may estimate the UE-specific 2D directional matrix. For example, the 2D directional orthogonal matrix may be correlated with the received signal, and a vector in the 2D orthogonal directional matrix may be selected which provides the largest correlation.

At block 430, the first device 110 may update the 2D Orthogonal directional matrix. For example, the 2D orthogonal directional matrix may be updated by removing the selected vector. At block 435, the first device 110 may update a residual signal of the received signal. For example, the residual signal may be updated by being projected onto the orthogonal subspace of the received signal.

At block 440, the first device 110 may compare the residual signal with a threshold. If the residual signal is equal to or greater than the threshold, the process 400 returns to block 410 where the first device 110 may continue to search over the 2D spatial frequency grids of the updated 2D orthogonal directional matrix 415. If the residual signal is less than the threshold, at block 445, the first device 110 may calculate channel gains. At block 450, the first device 110 may reconstruct the channel using the UE-specific 2D directional matrix and the channel gains. The channel reconstruction as described above with reference to FIG. 4 may be referred to as directional matrix based channel reconstruction.

By way of example, the equation (2) may be rewritten as the vectorization form

$$y = v ec ( Y ) = ( {X}^{T} ⊗ {I}_{{N}_{r}} ) v e c ( H ) + v e c ( N ) = ( {X}^{T} ⊗ {I}_{{N}_{r}} ) [ conj ( {A}_{t} ) ⊙ {A}_{r} ] a + n = CBa + n \qquad ( 11 )$$

where y represents the compressed signal, C=X^{T}⊗I_{N}_{ᵣ} represents the compression matrix, I_{N}_{ᵣ}∈ [symbol] ^{N}^{ᵣ}^{×N}^{ᵣ} represents the identify matrix, B=conj(Aₜ)⊙Aᵣ represents the specific 2D directional matrix, Aₜ=[aₜ(∂₁), aₜ(∂₂), . . . , aₜ(∂_{L})], Aᵣ=[aᵣ(φ₁), aᵣ(φ₂), . . . , aᵣ(φ_{L})], a=[a₁, a₂, . . . a_{L}]^{T},

$$n = {[ {n}_{1}^{T} , {n}_{2}^{T} , … {n}_{M}^{T} ]}^{T} ,$$

and ⊙ represents the Khatri-Rao product.

Based on the equation (11), the objective of channel reconstruction is to utilize y and C to reconstruct the vectorization form of the channel as

$$\tilde{h} = v e c ( \tilde{H} ) = \tilde{B} \tilde{a} \qquad ( 12 )$$

An example algorithm is shown below.

Example Algorithm

| Input: pilots X , received signal Y , 2D directional matrix B_{g} . | |
|---|---|
| Initialization: residual signal r = y , estimated | |
| UE-specific 2D directional matrix \tilde{B} = [ ]. | |
| (1) | While the estimated accuracy is not enough |
| (2) | s = arg max \| [CB_{g} ]^{T} r \| |
| (3) | \tilde{B} = \tilde{B}∪ B_{g} (s) |
| (4) | r = y − (C \tilde{B})(C \tilde{B})⁺ y |
| (5) | Remove the s -th column from B_{g} |
| (6) | End while |
| (7) | ã = (C \tilde{B})⁺ y |

Output: \tilde{h} =
\tilde{B} ã

The inputs of the example algorithm may be the complete 2D orthogonal directional matrix B_{g}, the received signal, and pilots (with a predefined pattern as will be detailed in the paragraphs with reference to FIGS. 5 and 6).

In the example algorithm, the OMP may be utilized. At Line (2), The OMP may start with searching over the 2D spatial frequency grids defined in the 2D orthogonal directional matrix by correlating the pilot-oriented 2D directional matrix (the term CB_{g}) with the residual signal and selecting the vector in the 2D orthogonal directional matrix that provides the largest correlation.

At Line (3), the UE-specific 2D directional matrix may be determined and constructed by the selected vector. At Line (4), the residual signal is updated by being projected onto the orthogonal subspace of the received signal. At Line (5), the 2D orthogonal directional matrix may be updated by removing the selected vector. The operations in Lines (2) to (5) may be repeated until the residual value, i.e., the norm of the residual signal, is smaller than a predetermined threshold.

At Line (7), the channel gains may be calculated by ã=(C\tilde{B})⁺y. At Output, the channel may be constructed by the UE-specific 2D directional matrix and the channel gains \tilde{h}=\tilde{B}ã.

Based on the reconstructed channel, the first device 110 may transmit channel state information (CSI) to the second device 120. Accordingly, the second device 120 as the Tx device may obtain more accurate channel state information.

FIG. 5 shows a flowchart of an example method 500 implemented at the second device 120 in accordance with some example embodiments of the present disclosure. For the purpose of discussion, the method 500 will be described with reference to FIGS. 1 and 2.

At block 510, the second device 120 transmits, to the first device 110, via a set of transmitting antennas elements (such as Tx AEs 205-1, 205-2, . . . , 205-Nₜ as shown in FIG. 2), a plurality of pilots (such as Pilot 1, . . . , Pilot M as shown in FIG. 2) with a pilot pattern. In the pilot pattern, a group of pilots of the plurality of pilots are active and other pilots of the plurality of pilots are muted. In some example embodiments, in the pilot pattern, transmitting angles of the plurality of pilots may be uniformly distributed in a spatial frequency range.

In some example embodiments, to mute some of the plurality of pilots, the second device 120 may apply a plurality of beam weights to the plurality of pilots. A first set of beam weights of the plurality of beam weights, which are not zero, may be applied to the group of pilots, and a second set of beam weights of the plurality of beam weights applied to other pilots of the plurality of pilots are set to zero. Then, the second device 120 may assign the group of pilots to a subset of transmitting antennas elements in the set of transmitting antennas elements. Thus, the group of pilots may be transmitted by the second device 120 via the subset of transmitting antennas elements.

In this way, the pilots may be divided into pilot groups which may be assigned to the corresponding antenna subsets. The beam weights from the desired antenna subset may be applied to the assigned pilots, and the beam weights of the rest antenna subsets may be muted. Thus, the pilots of different pilot groups may be transmitted from the corresponding antenna subsets to broaden the beam width.

An example process of generating partial muted pilots will be discussed below with reference to FIG. 6.

FIG. 6 shows a flowchart of an example process 600 of pilot muting implemented by the second device 120 according to some example embodiments of the present disclosure. For the purpose of discussion, the process 600 will be described with reference to FIGS. 1 and 2.

In the process 600, at block 610, the second device 120 may divide all AEs (such as Tx AEs 205-1, 205-2, . . . , 205-Nₜ) into G antenna subsets and M pilots (such as Pilot 1, . . . , Pilot M) into G pilot groups. At block 620, the second device 120 may apply beam weights to M pilots. The beam weights of the M pilots may be chosen such that they may uniformly sample the spatial frequency range. Thus, the transmitting angles of the M pilots may be uniformly distributed in the spatial frequency range.

At block 630, the second device 120 may assign a pilot group of P pilots to each antenna subset. At block 620, the second device 120 may mute the rest (M-P) pilots by setting the corresponding beam weights of M-P elements to zeros to broaden the beam width.

In some example embodiments, the pilot set may have a block diagonal structure to ensure that all AEs are utilized to provide the entire spatial space coverage and avoid the deep fading comes out at some AEs. The pilots of different pilot transmitted from the corresponding antenna subsets may form a block diagonal based partial muted pilot pattern. Such a design of the pilots may be referred to as a block diagonal based partial muted pilot design.

By way of example, the pilots may be divided into G groups, where

$$G = ⌊ {N}_{t} / M ⌋ \qquad ( 13 )$$

where └Ψ┘ represents the floor operation.

Each group may have P pilots, where

$$P = ⌊ \frac{{M}^{2}}{{N}_{t}} ⌋ \qquad ( 14 )$$

For any pilot {i=(g−1) P+p|g=1, 2, . . . G, p=1, 2, . . . P}, the spatial frequency may be denoted as

$${ϑ}_{i} = 2 π {D}_{t} [ 2 ( i - 1 ) / M - 1 ] \qquad ( 15 )$$

Therefore, pilot i may be represented as

$${x}_{i} = {a}_{t} ( {ϑ}_{i} ) ∘ {e}_{g} \qquad ( 16 )$$

where (o) denotes the Hadamard product and

$${e}_{g} = {[ 0 , … , {1 , … , 1}_{( g - 1 ) M + 1 : gM} , 0 , … 0 ]}^{T} .$$

Still with reference to FIG. 5, in some example embodiments, the second device 120 may transmit an indication of the pilot pattern to the first device 110. The indication may be explicit or implicit. For example, the pattern may be implicitly included in the beam weights, which may be predefined and known by both the second device 120 (as the Tx device) and the first device 110 (as the Rx device). The second device 120 may send the pilots via the predetermined beams so that the first device 110 may be able to acquire the pilot pattern. In some example embodiments, the active and muted pilot pattern may be fixed, for example, defined in the standards. Accordingly, the first device 110 may be aware of the pilot information and use it to reconstruct the channel more accurately.

At block 520, the second device 120 receives CSI from the first device 110. By utilizing the channel state information, the second device 120 may perform precoding or other transmission configurations in space to improve the efficiency of communication with the first device 110.

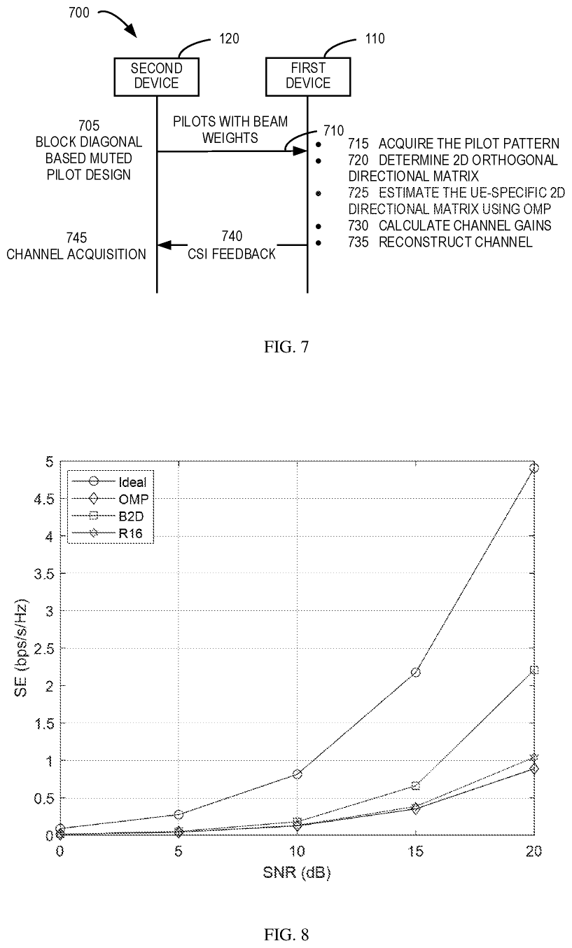

In some example embodiments, a block diagonal based partial muted pilot design, a 2D orthogonal directional matrix design, and a directional matrix based channel reconstruction may be used in combination to further improve the accuracy of the channel reconstruction. An example process will be discussed below with reference to FIG. 7.

FIG. 7 shows a signaling diagram 700 of channel reconstruction between the first and second devices 110 and 120 according to some example embodiments of the present disclosure.

As shown in FIG. 7, the second device 120 as a Tx device may perform (705) a block diagonal based partial muted pilot design and then transmit (710) the pilots with the corresponding beam weights via a channel. The first device 110 as a Rx device may acquire (715) the pilot pattern and determine (720) a 2D orthogonal directional matrix. Then, the first device 110 may estimate (725) a specific 2D directional matrix using OMP. The first device 110 may calculate (730) channel gains and reconstruct (735) the channel. The first device 110 may perform (740) CSI feedback to the second device 120. The second device 120 may perform (745) channel acquisition.

The simulation results show that the channel reconstruction scheme according to some example embodiments of the present disclosure may have a better performance compared to the OMP algorithm and the algorithm based on the above P1, P2 or P3 procedures in 3GPP Rel-16, which may be referred to as R16.

In the simulation, spectral efficiency (SE) is used as the performance metric. The channel consists of 10 frames, and each frame has 10 subframes. 4 paths are assumed. The path gain of each path is not changed during one subframe while it varies from one subframe to another subframe. The path angle (an AoA or an AoD) is not changed during one frame while it varies form one frame to another frame. There are 32 Tx AEs and 8 Rx AEs, the number of available pilots is 8. The relative inter-element distances of the Tx and Rx AEs is 0.5.

FIG. 8 shows an example graph of SE versus signal-noise ratio (SNR) of different algorisms according to some example embodiments of the present disclosure.

In FIG. 8, Ideal denotes the ideal case, OMP represents the OMP algorithm in], and B2D represents the scheme according to some example embodiments of the present disclosure. As shown in FIG. 8, the SE increases monotonously with the increase of SNR. Ideal has the best performance. B2D is better than OMP. For example, B2D has 63.15% average gain and 148.22% maximal gain compared with OMP.

In some example embodiments, a first apparatus capable of performing any of the method 300 (for example, the first device 110 in FIG. 1) may comprise means for performing the respective operations of the method 300. The means may be implemented in any suitable form. For example, the means may be implemented in a circuitry or software module. The first apparatus may be implemented as or included in the first device 110 in FIG. 1.

In some example embodiments, the first apparatus comprises means for receiving a signal from a second device via a set of receiving antenna elements over a channel, the signal associated with a plurality of pilots transmitted by the second device; means for determining an estimate of a plurality of pairs of transmitting and receiving angles associated with the channel, based on the received signal, the plurality of pilots and a plurality of orthogonal spatial directions, a spatial direction of the plurality of orthogonal spatial directions being indicated by a pair of transmitting and receiving spatial frequencies; and means for reconstructing the channel based on the received signal, the plurality of pilots, and the estimate of the plurality of pairs of transmitting and receiving angles.

In some example embodiments, the plurality of pilots has a pilot pattern, and in the pilot pattern, a group of pilots of the plurality of pilots are active and other pilots of the plurality of pilots are muted.

In some example embodiments, in the pilot pattern, transmitting angles of the plurality of pilots are uniformly distributed in a spatial frequency range.

In some example embodiments, the first apparatus further comprises: means for receiving an indication of the pilot pattern from the second device.

In some example embodiments, the means for determining the estimate of the plurality of pairs of transmitting and receiving angles comprises: means for iteratively searching over the plurality of orthogonal spatial directions based on the received signal and the plurality of pilots, to determine the estimate of the plurality of pairs of transmitting and receiving angles.

In some example embodiments, the means for iteratively searching over the plurality of orthogonal spatial directions comprises: means for searching, based on the received signal, for a first spatial direction from the plurality of orthogonal spatial directions; means for determining, based on the first spatial direction, a candidate estimate of the plurality of pairs of transmitting and receiving angles; means for updating a residual signal of the received signal based on the candidate estimate and the plurality of pilots; means for searching, based on the residual signal of the received signal, for a second spatial direction from remaining spatial directions of the plurality of orthogonal spatial directions; and means for updating the candidate estimate based on the second spatial direction.

In some example embodiments, the means for searching for the second spatial direction comprises: means for based on a determination that norm of the residual signal of the received signal is equal to or larger than a predetermined threshold, searching for the second spatial direction.

In some example embodiments, the first apparatus further comprises: means for based on a determination that the norm of the residual signal of the received signal is smaller than the predetermined threshold, ceasing the searching over the plurality of orthogonal spatial directions.

In some example embodiments, the means for reconstructing the channel comprises: means for determining a channel gain associated with the channel, based on the received signal, the plurality of pilots, and the estimate of the plurality of pairs of transmitting and receiving angles; and means for reconstructing the channel based on the channel gain and the estimate of the plurality of pairs of transmitting and receiving angles. In some example embodiments, the first apparatus further comprises: means for transmitting, based on the reconstructed channel, channel state information to the second device.

In some example embodiments, the first apparatus further comprises means for performing other operations in some example embodiments of the method 300 or the first device 110. In some example embodiments, the means comprises at least one processor; and at least one memory storing instructions that, when executed by the at least one processor, cause the performance of the first apparatus.

In some example embodiments, a second apparatus capable of performing any of the method 500 (for example, the second device 120 in FIG. 1) may comprise means for performing the respective operations of the method 500. The means may be implemented in any suitable form. For example, the means may be implemented in a circuitry or software module. The second apparatus may be implemented as or included in the second device 120 in FIG. 1.

In some example embodiments, the second apparatus comprises means for transmitting, to a first device, via a set of transmitting antennas elements, a plurality of pilots with a pilot pattern, wherein in the pilot pattern, a group of pilots of the plurality of pilots are active and other pilots of the plurality of pilots are muted; and means for receiving channel state information from the first device.

In some example embodiments, in the pilot pattern, transmitting angles of the plurality of pilots are uniformly distributed in a spatial frequency range.

In some example embodiments, the means for transmitting the plurality of pilots comprises: means for applying a plurality of beam weights to the plurality of pilots, wherein a first set of beam weights of the plurality of beam weights applied to the group of pilots that are not zero, and a second set of beam weights of the plurality of beam weights applied to other pilots of the plurality of pilots are set to zero; means for assigning the group of pilots to a subset of transmitting antennas elements in the set of transmitting antennas elements; and means for transmitting the group of pilots via the subset of transmitting antennas elements.

In some example embodiments, the second apparatus further comprises: means for transmitting an indication of the pilot pattern to the first device.

In some example embodiments, the second apparatus further comprises means for performing other operations in some example embodiments of the method 500 or the second device 120. In some example embodiments, the means comprises at least one processor; and at least one memory storing instructions that, when executed by the at least one processor, cause the performance of the second apparatus.

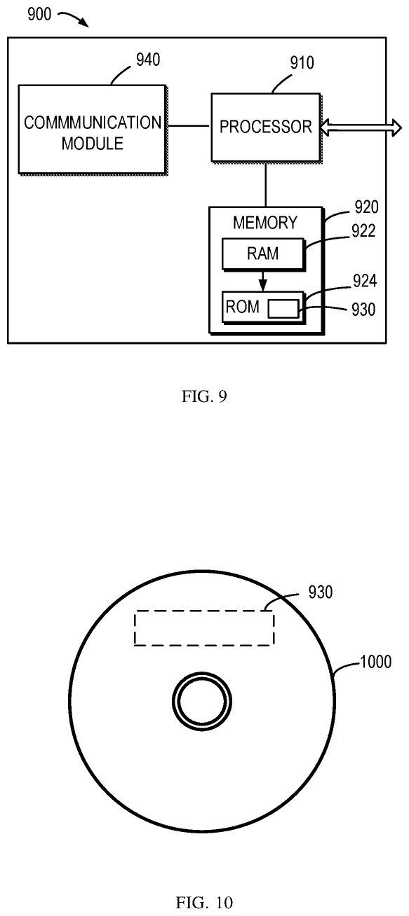

FIG. 9 is a simplified block diagram of a device 900 that is suitable for implementing example embodiments of the present disclosure. The device 900 may be provided to implement a communication device, for example, the first device 110 or the second device 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 1 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory storing instructions that, when executed by the at least one processor, cause the first device at least to perform:
receiving a signal from a second device via a set of receiving antenna elements over a channel, the signal associated with a plurality of pilots transmitted by the second device;
determining an estimate of a plurality of pairs of transmitting and receiving angles associated with the channel, based on the received signal, the plurality of pilots and a plurality of orthogonal spatial directions, a spatial direction of the plurality of orthogonal spatial directions being indicated by a pair of transmitting and receiving spatial frequencies; and
reconstructing the channel based on the received signal, the plurality of pilots, and the estimate of the plurality of pairs of transmitting and receiving angles.

2. The first device of claim 1, wherein the plurality of pilots has a pilot pattern, and in the pilot pattern, a group of pilots of the plurality of pilots are active and other pilots of the plurality of pilots are muted.

3. The first device of claim 2, wherein in the pilot pattern, transmitting angles of the plurality of pilots are uniformly distributed in a spatial frequency range.

4. The first device of claim 2, wherein the first device is further caused to perform:
receiving an indication of the pilot pattern from the second device.

5. The first device of claim 1, wherein determining the estimate of the plurality of pairs of transmitting and receiving angles comprises:
iteratively searching over the plurality of orthogonal spatial directions based on the received signal and the plurality of pilots, to determine the estimate of the plurality of pairs of transmitting and receiving angles.

6. The first device of claim 5, wherein iteratively searching over the plurality of orthogonal spatial directions comprises:
searching, based on the received signal, for a first spatial direction from the plurality of orthogonal spatial directions;
determining, based on the first spatial direction, a candidate estimate of the plurality of pairs of transmitting and receiving angles;
updating a residual signal of the received signal based on the candidate estimate and the plurality of pilots;
searching, based on the residual signal of the received signal, for a second spatial direction from remaining spatial directions of the plurality of orthogonal spatial directions; and
updating the candidate estimate based on the second spatial direction.

7. The first device of claim 6, wherein searching for the second spatial direction comprises:
based on a determination that norm of the residual signal of the received signal is equal to or larger than a predetermined threshold, searching for the second spatial direction.

8. The first device of claim 7, wherein the first device is further caused to perform:
based on a determination that the norm of the residual signal of the received signal is smaller than the predetermined threshold, ceasing the searching over the plurality of orthogonal spatial directions.

9. The first device of claim 1, wherein reconstructing the channel comprises:
determining a channel gain associated with the channel, based on the received signal, the plurality of pilots, and the estimate of the plurality of pairs of transmitting and receiving angles; and
reconstructing the channel based on the channel gain and the estimate of the plurality of pairs of transmitting and receiving angles.

10. The first device of claim 1, wherein the first device is further caused to perform:
transmitting, based on the reconstructed channel, channel state information to the second device.

11. A second device, comprising:
at least one processor; and
at least one memory storing instructions that, when executed by the at least one processor, cause the second device at least to perform:
transmitting, to a first device, via a set of transmitting antennas elements, a plurality of pilots with a pilot pattern, wherein in the pilot pattern, a group of pilots of the plurality of pilots are active and other pilots of the plurality of pilots are muted; and
receiving channel state information from the first device.

12. The second device of claim 11, wherein in the pilot pattern, transmitting angles of the plurality of pilots are uniformly distributed in a spatial frequency range.

13. The second device of claim 11, wherein transmitting the plurality of pilots comprises:
applying a plurality of beam weights to the plurality of pilots, wherein a first set of beam weights of the plurality of beam weights applied to the group of pilots that are not zero, and a second set of beam weights of the plurality of beam weights applied to other pilots of the plurality of pilots are set to zero;
assigning the group of pilots to a subset of transmitting antennas elements in the set of transmitting antennas elements; and
transmitting the group of pilots via the subset of transmitting antennas elements.

14. The second device of claim 11, wherein the second device is further caused to perform:
transmitting an indication of the pilot pattern to the first device.

15-31. (canceled)
